(19) United States
(12) Patent Application Publication
(10) Pub. No.: US 2024/0246033 A1
(43) Pub. Date: Jul. 25, 2024

(54) SPACERS FOR FILTRATION APPLICATIONS

(71) Applicant: ENTEGRIS, INC., Billerica, MA (US)

(72) Inventors: Zhifeng Li, Acton, MA (US); John P. Puglia, Townsend, MA (US)

(21) Appl. No.: 18/420,661

(22) Filed: Jan. 23, 2024

Related U.S. Application Data
(60) Provisional application No. 63/440,631, filed on Jan. 23, 2023.

(51) Int. Cl. B01D 63/06; D03D 1/00; D03D 9/00; D03D 15/283

(52) U.S. Cl. CPC B01D 63/067; D03D 1/00; D03D 9/00; D03D 15/283; B01D 2313/143; B01D 2313/146; D10B 2321/12; D10B 2505/04

(57) ABSTRACT

Spacers for filtration applications are provided. A spacer for a filtration device comprises a substrate comprising a cyclic polyolefin. The substrate comprises a plurality of through-holes for filtering particles having an average particle size of greater than 50 μm. Filtration assemblies, filtration devices, and related systems and methods are also provided.

### FIELD

The present disclosure relates to spacers for filtration applications and related systems, apparatuses, devices, and methods.

### BACKGROUND

The presence of impurities on components of filtration devices is problematic, especially for applications requiring high purity. The filtering process can cause these impurities, or extractables, to be released from the component, thereby contaminating the filtered fluid.

### SUMMARY

Some embodiments relate to a spacer for a filtration device. In some embodiments, the spacer comprises a substrate that comprises a cyclic polyolefin. In some embodiments, the substrate comprises a plurality of through-holes for filtering particles having an average particle size of greater than 50 μm.

Some embodiments relate to a filtration assembly. In some embodiments, the filtration assembly comprises a spacer. In some embodiments, the filtration assembly comprises a membrane upstream of the spacer. In some embodiments, the filtration assembly comprises a membrane downstream of the spacer. In some embodiments, the filtration assembly comprises a membrane upstream of the spacer and downstream of the spacer. In some embodiments, the spacer comprises a cyclic polyolefin and a plurality of through-holes for filtering particles having an average particle size of greater than 50 μm.

Some embodiments relate to a filtration device. In some embodiments, the filtration device comprises a housing having an inlet and an outlet. In some embodiments, the filtration device comprises a filtration assembly disposed in the housing between the inlet and the outlet. In some embodiments, the filtration assembly comprises a spacer. In some embodiments, the filtration assembly comprises a membrane upstream of the spacer. In some embodiments, the filtration assembly comprises a membrane downstream of the spacer. In some embodiments, the filtration assembly comprises a membrane upstream of the spacer and downstream of the spacer. In some embodiments, the spacer comprises a cyclic polyolefin and a plurality of through-holes for filtering particles having an average particle size of greater than 50 μm.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a perspective view of a filtration device including spacers, according to some embodiments.

FIG. 2 is a cross-sectional view of a filtration member, according to some embodiments.

FIG. 3 is a cross-sectional view of a filtration member, according to some embodiments.

FIG. 4 is a scanning electron microscope (SEM) image of polymer fibers comprising the cyclic olefin copolymers, according to some embodiments.

FIG. 5 is a SEM image of the polymer fibers woven into the spacer, according to some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Any prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “alkene” refers to an unsaturated hydrocarbon containing at least one carbon-carbon double bond. The term includes C₄-C₂₀ olefins and C₄-C₂₀ alpha-olefins, among others. Non-limiting examples of alkenes include at least one of ethene, propene, butene, pentene, hexene, heptane, octene, nonene, decene, dodecene, tetradecene, hexadecene, octadecene, eicosene, docosene, tetracosene, hexacosene, octacosene, triacontene, 3-methyl-1-butene, 3-methyl-1-pentene, 4-methyl-1-pentene, 4,6-dimethyl-1-heptene, C₄-C₄₀ dienes, isomers thereof, alpha-olefins thereof, or any combination thereof. Non-limiting examples of C₄-C₄₀ dienes include at least one of 1,3-butadiene, 1,3-pentadiene, 1,4-hexadiene, 1,5-hexadiene, 1,7-octadiene, 1,9-decadiene, or any combination thereof. Non-limiting examples of alpha-olefins include at least one of 1-propene, 1-butene, 1-pentene, 1-hexene, 1-heptene, 1-octene, 1-nonene, 1-decene, 1-dodecene, 1-tetradecene, 1-hexadecene, 1-octadecene, 1-eicosene, 1-docosene, 1-tetracosene, 1-hexacosene, 1-octacosene, 1-triacontene, or any combination thereof.

As used herein, the term “cycloalkene” refers to an unsaturated hydrocarbon ring structure containing at least one carbon-carbon double bond in the ring structure. The term includes cyclic olefins, as well as bicycloalkenes, tricycloalkenes, and tetracycloalkenes. Non-limiting examples of cycloalkenes include at least one of cyclopropenes, cyclobutenes, cyclopentenes (e.g., cyclopentene, 1-methylcyclopentene, and the like), dicyclopentadiene, cyclohexenes, cyclohexadienes (e.g., 1,3-cyclohexadiene, 1,4-cyclohexadiene, and the like), cycloheptenes, cyclooctenes, cyclooctadienes (e.g., 1,5-cyclooctadiene, and the like), cyclononanes, cyclodecenes, tetracyclododecene, norbornene, norbornene derivatives (e.g., 5-methyl norbornene, bicyclo[2.2.1]hept-2-ene, ethylidene norbornene, vinyl norbornene, dicyclopentadiene, and the like), or any combination thereof.

As used herein, the term “cyclic olefin copolymer” (COC) refers to a copolymer comprising a cyclic olefin. In some embodiments, the cyclic olefin copolymer comprises a copolymer of a cyclic olefin and another monomer. In some embodiments, the cyclic olefin copolymer comprises a copolymer of a cyclic olefin and an olefin. In some embodiments, the cyclic olefin copolymer comprises a copolymer of a cyclic olefin and an alpha-olefin. In some embodiments, the cyclic olefin copolymer is prepared by copolymerization of the monomers. Non-limiting examples of cyclic olefin copolymers include those commercially available under APEL® by Mitsui and TOPAS® by TOPAS advanced polymers.

As used herein, the term “cyclic olefin polymer” (COP) refers to a polymer comprising a cyclic olefin. In some embodiments, the cyclic olefin is present in a polymer backbone of the polymer. In some embodiments, the cyclic olefin polymer is prepared by ring-opening metathesis polymerization (ROMP) of a cyclic olefin followed by hydrogenation. Non-limiting examples of cyclic olefin polymers include those commercially available under Zeonex® and Zeonor® by Zeon and Arton® by Japan Synthetic Rubber (JSR). In some embodiments, the cyclic olefin is attached to the polymer backbone of the polymer, such as, for example and without limitation, as a pendent group attached to the polymer backbone of the polymer.

As used herein, the term “cyclic block copolymer” refers to a block copolymer comprising a cyclic compound. In some embodiments, the cyclic block copolymer comprises a copolymer of styrene and conjugated diene(s). In some embodiments, the styrene is a fully hydrogenated styrene. In some embodiments, the cyclic block copolymer is produced via anionic polymerization. Non-limiting examples of conjugated dienes include at least one of 1,3-pentadiene, 1,3-butadiene, 2-methyl-1,3-butadiene, 4-methyl-1,3-pentadiene, 1,3-cyclopentadiene, or any combination thereof.

As used herein, the term “cyclic polyolefin” refers to at least one of a cyclic olefin copolymer, a cyclic olefin polymer, a cyclic block copolymer, or any combination thereof.

As used herein, the term “polymeric impurity” refers to at least one of an oligomer impurity, a monomer impurity, or any combination thereof.

Some embodiments relate to spacers useful for improving the performance of filtration devices and related methods. At least one advantage of the spacers disclosed herein is that, unlike conventional spacers, the spacers disclosed herein have low levels of impurities. As used herein, the term “impurity” generally refers to an undesirable substance that, for example, through a filtering process, is or may be present in a filtered product. An impurity may, for example, be a byproduct, a residue, or another substance resulting from at least one of the fabrication of the spacer, a pre-fabrication process, a post-fabrication process, or any combination thereof. Examples of impurities include, without limitation, at least one of metals, oligomers, monomers, or any combination thereof.

The spacer may comprise a substrate. In some embodiments, the substrate comprises a plurality of through-holes. In some embodiments, the substrate is a non-woven substrate. In some embodiments, the plurality of through-holes is formed in the non-woven substrate. In some embodiments, the substrate is a woven substrate. In some embodiments, the woven substrate comprises a plurality of fibers. In some embodiments, the plurality of fibers is woven so as to obtain the plurality of through-holes.

The substrate may be configured to provide pre-filtration of a fluid prior to the fluid flowing through a membrane. That is, in some embodiments, the substrate is configured to inhibit at least a portion of particles from passing through the spacer (e.g., based on difference in size between the plurality of through-holes and the particles to be filtered). In some embodiments, the substrate is configured to filter larger particles relative to the particles being filtered by the membrane. In some embodiments, the substrate is configured to filter particles having an average particle size of greater than 50 μm, greater than 100 μm, greater than 200 μm, greater than 210 μm, greater than 220 μm, greater than 230 μm, greater than 240 μm, greater than 250 μm, greater than 260 μm, greater than 270 μm, greater than 280 μm, greater than 290 μm, or greater than 300 μm.

In some embodiments, the substrate is configured to filter particles having an average particle size of 50 μm to 300 μm, or any range or subrange therebetween. For example, in some embodiments, the average particle size of the particles being filtered is 50 μm to 280 μm, 50 μm to 260 μm, 50 μm to 250 μm, 50 μm to 240 μm, 50 μm to 220 μm, 50 μm to 200 μm, 50 μm to 180 μm, 50 μm to 160 μm, 50 μm to 150 μm, 50 μm to 140 μm, 50 μm to 120 μm, 50 μm to 100 μm, 50 μm to 80 μm, 50 μm to 60 μm, 60 μm to 300 μm, 80 μm to 300 μm, 100 μm to 300 μm, 120 μm to 300 μm, 140 μm 300 μm, 150 μm to 300 μm, 160 μm to 300 μm, 180 μm to 300 μm, 220 μm to 300 μm, 240 μm 300 μm, 250 μm to 300 μm, 260 μm to 300 μm, or 280 μm to 300 μm.

In some embodiments, the substrate is configured to filter particles having an average particle size of 200 μm to 300 μm, or any range or subrange therebetween. For example, in some embodiments, the average particle size of the particles being filtered is 200 μm to 295 μm, 200 μm to 290 μm, 200 μm to 285 μm, 200 μm to 280 μm, 200 μm to 275 μm, 200 μm to 270 μm, 200 μm to 265 μm, 200 μm to 260 μm, 200 μm to 255 μm, 200 μm to 250 μm, 200 μm to 245 μm, 200 μm to 240 μm, 200 μm to 235 μm, 200 μm to 230 μm, 200 μm to 225 μm, 200 μm to 220 μm, 200 μm to 215 μm, 200 μm to 210 μm, 200 μm to 205 μm, 205 μm to 300 μm, 210 μm to 300 μm, 215 μm to 300 μm, 220 μm to 300 μm, 225 μm to 300 μm, 230 μm to 300 μm, 235 μm to 300 μm, 240 μm to 300 μm, 245 μm to 300 μm, 250 μm to 300 μm, 255 μm to 300 μm, 260 μm to 300 μm, 265 μm to 300 μm, 270 μm to 300 μm, 275 μm to 300 μm, 280 μm to 300 μm, 285 μm to 300 μm, 290 μm to 300 μm, or 295 μm to 300 μm.

In some embodiments, the substrate comprises or consists of a cyclic polyolefin. In some embodiments, for example, the substrate comprises or consists of at least one of a cyclic olefin copolymer (COC), a cyclic block copolymer (CBC), a cyclic olefin polymer (COP), or any combination thereof. In some embodiments, the plurality of fibers comprises or consists of a cyclic polyolefin. In some embodiments, for example, the plurality of fibers comprises or consists of at least one of a cyclic olefin copolymer, a cyclic block copolymer, a cyclic olefin copolymer, or any combination thereof.

The plurality of fibers may have an average fiber diameter of 10 μm to 500 μm, or any range or subrange therebetween. In some embodiments, the plurality of fibers have an average fiber diameter of 10 μm to 475 μm, 10 μm to 450 μm, 10 μm to 425 μm, 10 μm to 400 μm, 10 μm to 375 μm, 10 μm to 350 μm, 10 μm to 325 μm, 10 μm to 300 μm, 10 μm to 275 μm, 10 μm to 250 μm, 10 μm to 225 μm, 10 μm to 200 μm, 10 μm to 175 μm, 10 μm to 150 μm, 10 μm to 125 μm, 10 μm to 100 μm, 10 μm to 75 μm, 10 μm to 50 μm, 10 μm to 25 μm, 25 μm to 500 μm, 50 μm to 500 μm, 75 μm to 500 μm, 100 μm to 500 μm, 125 μm to 500 μm, 150 μm to 500 μm, 175 μm to 500 μm, 200 μm to 500 μm, 225 μm to 500 μm, 250 μm to 500 μm, 275 μm to 500 μm, 300 μm to 500 μm, 325 μm to 500 μm, 350 μm to 500 μm, 375 μm to 500 μm, 400 μm to 500 μm, 425 μm to 500 μm, 450 μm to 500 μm, or 475 μm to 500 μm,

The substrate may have a thickness of 20 μm to 1000 μm, or any range or subrange therebetween. In some embodiments, the substrate has a thickness of 20 μm to 950 μm, 20 μm to 900 μm, 20 μm to 850 μm, 20 μm to 800 μm, 20 μm to 750 μm, 20 μm to 700 μm, 20 μm to 650 μm, 20 μm to 600 μm, 20 μm to 550 μm, 20 μm to 500 μm, 20 μm to 450 μm, 20 μm to 400 μm, 20 μm to 350 μm, 20 μm to 300 μm, 20 μm to 250 μm, 20 μm to 200 μm, 20 μm to 150 μm, 20 μm to 100 μm, 20 μm to 50 μm, 50 μm to 1000 μm, 100 μm to 1000 μm, 150 μm to 1000 μm, 200 μm to 1000 μm, 250 μm to 1000 μm, 300 μm to 1000 μm, 350 μm to 1000 μm, 400 μm to 1000 μm, 450 μm to 1000 μm, 500 μm to 1000 μm, 550 μm to 1000 μm, 600 μm to 1000 μm, 650 μm to 1000 μm, 700 μm to 1000 μm, 750 μm to 1000 μm, 800 μm to 1000 μm, 850 μm to 1000 μm, 900 μm to 1000 μm, or 950 μm to 1000 μm.

The substrate may have low levels of impurities. In some embodiments, impurity level may be determined by soaking the substrate in a solution of 10% HCl and isopropyl alcohol for about 24 hours and then measuring the solution for a presence of the impurity. In some embodiments, the substrate comprises low levels of metal impurity. In some embodiments, the metal impurity comprises at least one of a sodium impurity, a magnesium impurity, an aluminum impurity, a potassium impurity, a calcium impurity, an iron impurity, a zinc impurity, or any combination thereof. In some embodiments, the metal impurity comprises at least one of sodium, magnesium, aluminum, potassium, calcium, iron, zinc, or any combination thereof.

In some embodiments, the substrate comprises 2 μg or less of the metal impurity per gram of the substrate, or any range or subrange between no metal impurity and 2 μg of metal impurity per gram of the substrate. For example, in some embodiments, the substrate comprises 0.001 μg to 2 μg, 0.01 μg to 2 μg, 0.1 μg to 2 μg, 0.2 μg to 2 μg, 0.3 μg to 2 μg, 0.4 μg to 2 μg, 0.5 μg to 2 μg, 0.6 μg to 2 μg, 0.7 μg to 2 μg, 0.8 μg to 2 μg, 0.9 μg to 2 μg, 1 μg to 2 μg, 1.1 μg to 2 μg, 1.2 μg to 2 μg, 1.3 μg to 2 μg, 1.4 μg to 2 μg, 1.5 μg to 2 μg, 1.6 μg to 2 μg, 1.7 μg to 2 μg, 1.8 μg to 2 μg, 1.9 μg to 2 μg, 0.001 μg to 1.9 μg, 0.001 μg to 1.8 μg, 0.001 μg to 1.7 μg, 0.001 μg to 1.6 μg, 0.001 μg to 1.5 μg, 0.001 μg to 1.4 μg, 0.001 μg to 1.3 μg, 0.001 μg to 1.2 μg, 0.001 μg to 1.1 μg, 0.001 μg to 1 μg, 0.001 μg to 0.9 μg, 0.001 μg to 0.8 μg, 0.001 μg to 0.7 μg, 0.001 μg to 0.6 μg, 0.001 μg to 0.5 μg, 0.001 μg to 0.4 μg, 0.001 μg to 0.3 μg, 0.001 μg to 0.2 μg, 0.001 μg to 0.1 μg, or 0.001 μg to 0.01 μg.

In some embodiments, the substrate comprises low levels of polymeric impurity. In some embodiments, the polymeric impurity has a weight average molecular weight of 2000 g/mol or less, or any range or subrange between 100 g/mol and 2000 g/mol. In some embodiments, the polymeric impurity comprises has a weight average molecular weight of 100 g/mol to 1900 g/mol, 100 g/mol to 1800 g/mol, 100 g/mol to 1700 g/mol, 100 g/mol to 1600 g/mol, 100 g/mol to 1500 g/mol, 100 g/mol to 1400 g/mol, 100 g/mol to 1300 g/mol, 100 g/mol to 1200 g/mol, 100 g/mol to 1100 g/mol, 100 g/mol to 1000 g/mol, 100 g/mol to 900 g/mol, 100 g/mol to 800 g/mol, 100 g/mol to 700 g/mol, 100 g/mol to 600 g/mol, 100 g/mol to 500 g/mol, 100 g/mol to 400 g/mol, 100 g/mol to 300 g/mol, 100 g/mol to 200 g/mol, 200 g/mol to 1900 g/mol, 300 g/mol to 1900 g/mol, 400 g/mol to 1900 g/mol, 500 g/mol to 1900 g/mol, 600 g/mol to 1900 g/mol, 700 g/mol to 1900 g/mol, 800 g/mol to 1900 g/mol, 900 g/mol to 1900 g/mol, 1000 g/mol to 1900 g/mol, 1100 g/mol to 1900 g/mol, 1200 g/mol to 1900 g/mol, 1300 g/mol to 1900 g/mol, 1400 g/mol to 1900 g/mol, 1500 g/mol to 1900 g/mol, 1600 g/mol to 1900 g/mol, 1700 g/mol to 1900 g/mol, or 1800 g/mol to 1900 g/mol.

In some embodiments, the substrate comprises less than 5% by weight of the polymeric impurity, or any range or subrange between 0.0001% to 5% by weight of the polymeric impurity. In some embodiments, for example, the substrate comprises less than 4.8%, less than 4.6%, less than 4.4%, less than 4.2%, less than 4%, less than 3.8%, less than 3.6%, less than 3.4%, less than 3.2%, less than 3%, less than 2.8%, less than 2.6%, less than 2.4%, less than 2.2%, less than 2%, less than 1.8%, less than 1.6%, less than 1.4%, less than 1.2%, less than 1%, less than 0.8%, less than 0.6%, less than 0.4%, less than 0.2%, less than 0.1%, less than 0.01%, less than 0.001%, or less than 0.0001% by weight of the polymeric impurity based on a total weight of the substrate.

In some embodiments, a filter comprises one or more spacers next to, between, and/or around a membrane. In some embodiments, an average pore size of a membrane is at least 100 times smaller than an average pore size of a spacer. In some embodiments, a spacer is configured to allow for flow through the filter and/or to increase turbulence of the flow, while imparting no measurable contribution toward pressure drop across the filter (e.g., without impacting a pressure drop across the filtration device by more than 1%). In some embodiments, a spacer is a screen that serves various functions within a filter. For example, in some embodiments, a feed spacer is included in a filter to prevent a membrane from sticking to itself and to prevent channeling of the filter feed, both of which lessen the productivity of the filter. In some embodiments, a spacer provides support and protection to a membrane. For example, a spacer prevents damage to the membrane by cushioning the membrane and preventing it from abrading against itself or other elements located in a filter housing. In some embodiments, a spacer is a support structure for a pleated or an unpleated membrane, thereby forming a composite structure within a filtration device. In some embodiments, a spacer is not a membrane for filtration.

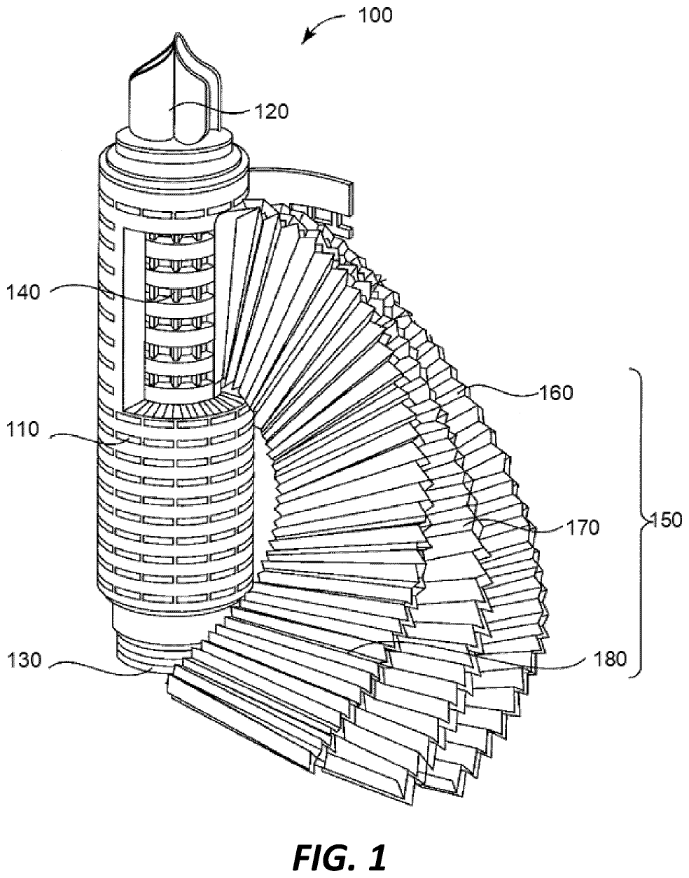

FIG. 1 is a perspective view of a filtration device 100, according to some embodiments. As shown in FIG. 1, the filtration device 100 comprises a housing 110 with an endcap 120 at a first end and a fluid fitting 130 at a second end. A core 140 is disposed within the housing 110, with a filtration assembly 150 disposed about the core 140. The filtration assembly 150 comprises an upstream spacer 160, a membrane 170, and a downstream spacer 180. The membrane 170 is shown sandwiched between the upstream spacer 160 and the downstream spacer 180. In the illustrated embodiment, the upstream spacer 160, the membrane 170, and the downstream spacer 180 are shown in a pleated configuration.

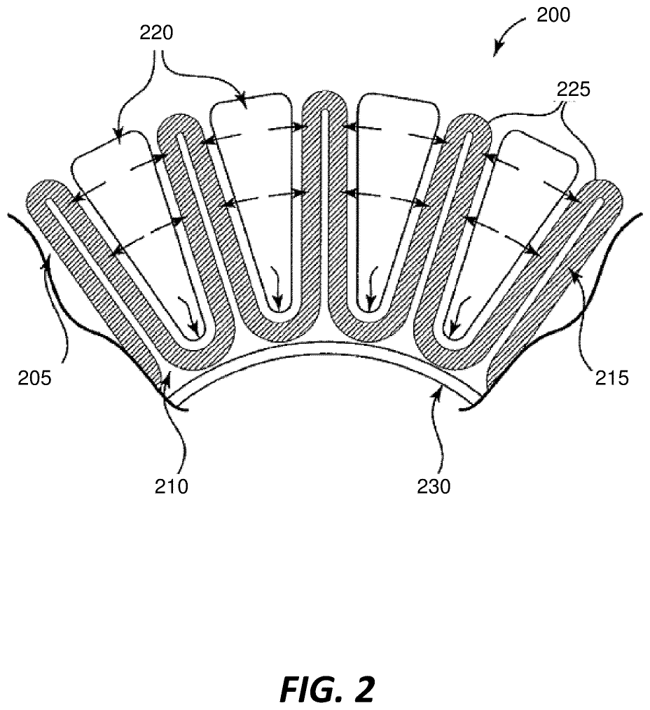

FIG. 2 is a cross-sectional view of a filtration assembly 200, according to some embodiments. As shown in FIG. 2, the filtration assembly 200 comprises an upstream spacer 205, a downstream spacer 210, and a membrane 215 between the upstream spacer 206 and the downstream spacer 210. In some embodiments, the upstream spacer 205 directly contacts the membrane 215. In some embodiments, the downstream spacer 210 directly contacts the membrane 215. In some embodiments, the upstream spacer 206, the downstream spacer 210, and the membrane 215 are shown in a pleated configuration. A feed may enter any one or more of the volumes 220 between pleats 225. Upon entering the volumes 220, the feed flows through the upstream spacer 205 to the membrane 215. As the feed flows through the membrane 215, the feed is filtered and, upon exiting the membrane 215, flows through the downstream spacer 210 to the core 230.

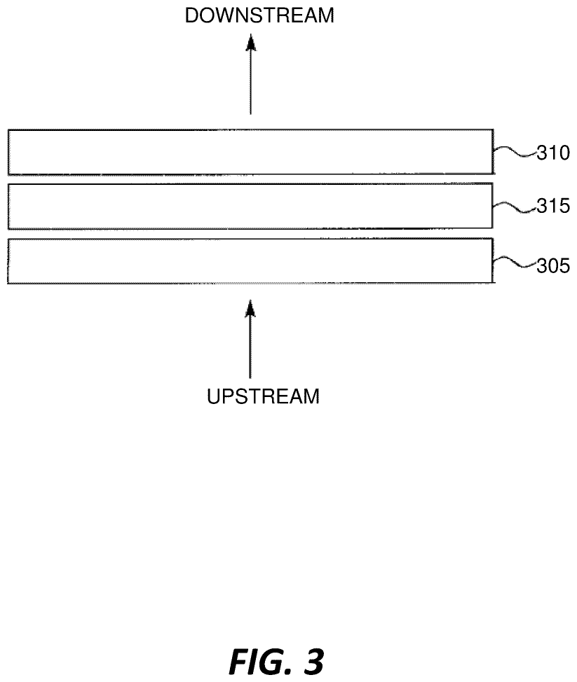

FIG. 3 is a cross-sectional view of a filtration assembly 300, according to some embodiments. As shown in FIG. 3, the filtration assembly 300 comprises an upstream spacer 305, a downstream spacer 310, and a membrane 315 between the upstream spacer 305 and the downstream spacer 310. In some embodiments, the upstream spacer 305 contacts at least a portion of the membrane 315. In some embodiments, the downstream spacer 310 contacts at least a portion of the membrane 315. Although the filtration assembly 300 is shown with both the upstream spacer 305 and the downstream spacer 310, it will be appreciated that the filtration assembly 300 may comprise additional spacers or fewer spacers, on either or both the upstream side and the downstream side of the filtration assembly 300. For example, in some embodiments, the filtration assembly 300 does not comprise at least one of the upstream spacer 305, the downstream spacer 310, or any combination thereof. In some embodiments, the filtration assembly 300 comprises at least one additional spacer on at least one of the upstream side or the downstream side of the filtration assembly 300. In some embodiments, the filtration assembly 300 does not comprise a third spacer, either upstream or downstream of the membrane 315. In some embodiments, the filtration assembly 300 does not comprise a second filtration membrane (i.e., comprises only a single filtration membrane).

### Example 1

Polymer fibers comprising cyclic polyolefins were extruded and woven into a substrate. Sample 1 comprises polymer fibers of a cyclic olefin copolymer (COC). Sample 2 comprises polymer fibers of a cyclic block copolymer (CBC). Sample 3 is a control spacer comprising high density polyethylene (HDPE) and polypropylene (PP). In contrast to polyethylene copolymers, polyethylenes cannot be woven due to crystalline cracking. The impurity levels of samples 1 to 3 were measured by soaking each sample in a solution of 10% HCl and isopropyl alcohol for about 24 hours and then measuring the resulting solution for a presence of metals and polymeric impurity (e.g., at least one of an oligomer, a monomer, or any combination thereof) having a weight average molecular weight of less than 2000 g/mol. Weight percentages are based on a total weight of each sample. The results are summarized in Table 1 below.

| | | Weight Percentage of |
|---|---|---|
| | Total Metals | Polymeric Impurity |
| Sample | (μg/g) | (<2000 g mol⁻¹) |
| Sample 1 | 0.7 | Not Detectable |
| Sample 2 | 0.4 | Not Detectable |
| Sample 3 | >3 | >4% |

### Example 2

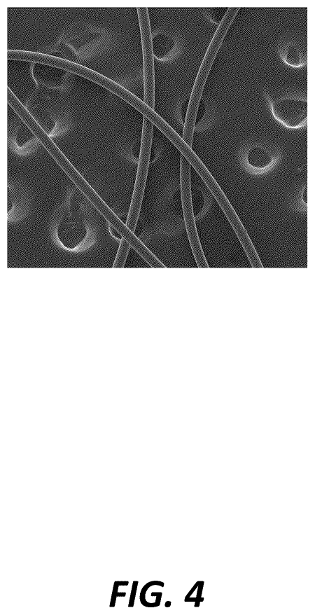

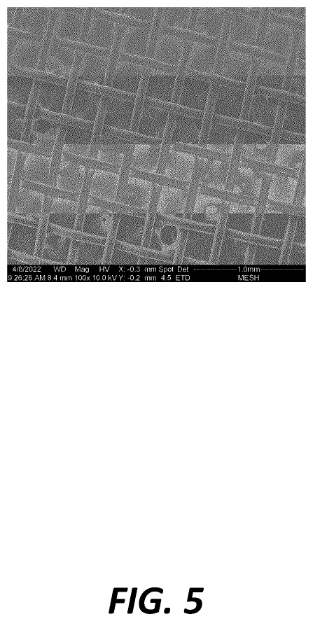

Various polymer fibers comprising cyclic olefin copolymers were extruded and weaved into woven substrates. The polymer fibers comprising the cyclic olefin copolymers had fiber diameters in a range of 50 microns to 80 microns. These polymer fibers were woven into a spacer having a thickness of 160 microns. The impurity levels of the spacer were measured by soaking the spacer in a solution of 10% HCl and isopropyl alcohol for about 24 hours and then measuring the resulting solution for a presence of metals. The spacer had less than 4% μg/g of total impurities which included sodium, magnesium aluminum, potassium, calcium, iron, and zinc. FIG. 4 is a scanning electron microscope (SEM) image of polymer fibers comprising the cyclic olefin copolymers, according to some embodiments. FIG. 5 is a SEM image of the polymer fibers woven into the spacer, according to some embodiments.

### Aspects

Various Aspects are described below. It is to be understood that any one or more of the features recited in the following Aspect(s) can be combined with any one or more other Aspect(s).

Aspect 1. A spacer for a filtration device, the spacer comprising:
a substrate comprising a cyclic polyolefin,
   wherein the substrate comprises a plurality of through-holes for filtering particles having an average particle size of greater than 50 μm.

Aspect 2. The spacer according to Aspect 1, wherein the cyclic polyolefin comprises a cyclic olefin copolymer.

Aspect 3. The spacer according to any one of Aspects 1-2, wherein the cyclic polyolefin comprises a cyclic block copolymer.

Aspect 4. The spacer according to any one of Aspects 1-3, wherein the cyclic polyolefin comprises a cyclic olefin polymer.

Aspect 5. The spacer according to any one of Aspects 1-4, wherein the substrate comprises 2 μg or less of a metal impurity per gram of the substrate.

Aspect 6. The spacer according to Aspect 5, wherein the metal impurity comprises at least one of sodium, magnesium, aluminum, potassium, calcium, iron, zinc, or any combination thereof.

Aspect 7. The spacer according to any one of Aspects 1-6, wherein the substrate comprises less than 5% by weight of a polymeric impurity based on a total weight of the substrate.

Aspect 8. The spacer according to Aspect 7, wherein the polymeric impurity has a weight average molecular weight of 2000 g/mol or less.

Aspect 9. The spacer according to any one of Aspects 1-8, wherein the substrate is a woven substrate comprising:
a plurality of fibers comprising the cyclic polyolefin;
   wherein the plurality of fibers is woven so as to obtain the plurality of through-holes.

Aspect 10. The spacer according to Aspect 9, wherein the plurality of fibers has a fiber diameter of 10 μm to 500 μm.

Aspect 11. The spacer according to Aspect 9, wherein the substrate has a thickness of 20 μm to 1000 μm.

Aspect 12. A filtration device comprising:
a housing having an inlet and an outlet;
a filtration assembly disposed in the housing between the inlet and the outlet, the filtration assembly comprising:
   a spacer; and
   a membrane upstream or downstream of the spacer;
      wherein the spacer comprises:
         a cyclic polyolefin; and
         a plurality of through-holes for filtering particles having an average particle size of greater than 50 μm.

Aspect 13. The filtration device according to Aspect 12, wherein the cyclic polyolefin comprises at least one of a cyclic olefin copolymer, a cyclic block copolymer, a cyclic olefin polymer, or any combination thereof.

Aspect 14. The filtration device according to any one of Aspects 12-13, wherein the spacer comprises 2 μg or less of a metal impurity per gram of the spacer.

Aspect 15. The filtration device according to Aspect 14, wherein the metal impurity comprises at least one of sodium, magnesium, aluminum, potassium, calcium, iron, zinc, or any combination thereof.

Aspect 16. The filtration device according to any one of Aspects 12-15, wherein the spacer comprises less than 5% by weight of a polymeric impurity based on a total weight of the spacer.

Aspect 17. The filtration device according to Aspect 16, wherein the polymeric impurity has a weight average molecular weight of 2000 g/mol or less.

Aspect 18. A filtration device comprising:
a housing having an inlet and an outlet;
a filtration assembly disposed in the housing between the inlet and the outlet, the filtration assembly comprising:
   a spacer; and
   a membrane upstream or downstream of the spacer;
      wherein the spacer comprises a plurality of fibers that comprise a cyclic polyolefin;
         wherein the plurality of fibers is woven to obtain a plurality of through-holes for filtering particles having an average particle size of greater than 50 μm.

Aspect 19. The filtration device according to Aspect 18, wherein the plurality of fibers has a fiber diameter of 10 μm to 500 μm.

Aspect 20. The filtration device according to any one of Aspects 18-19, wherein a thickness of the spacer is 20 μm to 1000 μm.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A spacer for a filtration device, the spacer comprising:
a substrate comprising a cyclic polyolefin,
wherein the substrate comprises a plurality of through-holes for filtering particles having an average particle size of greater than 50 μm.

2. The spacer of claim 1, wherein the cyclic polyolefin comprises a cyclic olefin copolymer.

3. The spacer of claim 1, wherein the cyclic polyolefin comprises a cyclic block copolymer.

4. The spacer of claim 1, wherein the cyclic polyolefin comprises a cyclic olefin polymer.

5. The spacer of claim 1, wherein the substrate comprises 2 μg or less of a metal impurity per gram of the substrate.

6. The spacer of claim 5, wherein the metal impurity comprises at least one of sodium, magnesium, aluminum, potassium, calcium, iron, zinc, or any combination thereof.

7. The spacer of claim 1, wherein the substrate comprises less than 5% by weight of a polymeric impurity based on a total weight of the substrate.

8. The spacer of claim 7, wherein the polymeric impurity has a weight average molecular weight of 2000 g/mol or less.

9. The spacer of claim 1, wherein the substrate is a woven substrate comprising:
a plurality of fibers comprising the cyclic polyolefin;
wherein the plurality of fibers is woven so as to obtain the plurality of through-holes.

10. The spacer of claim 9, wherein the plurality of fibers has a fiber diameter of 10 μm to 500 μm.

11. The spacer of claim 9, wherein the substrate has a thickness of 20 μm to 1000 μm.

12. A filtration device comprising:
a housing having an inlet and an outlet;
a filtration assembly disposed in the housing between the inlet and the outlet, the filtration assembly comprising:
a spacer; and
a membrane upstream or downstream of the spacer;
wherein the spacer comprises:
a cyclic polyolefin; and
a plurality of through-holes for filtering particles having an average particle size of greater than 50 μm.

13. The filtration device of claim 12, wherein the cyclic polyolefin comprises at least one of a cyclic olefin copolymer, a cyclic block copolymer, a cyclic olefin polymer, or any combination thereof.

14. The filtration device of claim 12, wherein the spacer comprises 2 μg or less of a metal impurity per gram of the spacer.

15. The filtration device of claim 14, wherein the metal impurity comprises at least one of sodium, magnesium, aluminum, potassium, calcium, iron, zinc, or any combination thereof.

16. The filtration device of claim 12, wherein the spacer comprises less than 5% by weight of a polymeric impurity based on a total weight of the spacer.

17. The filtration device of claim 16, wherein the polymeric impurity has a weight average molecular weight of 2000 g/mol or less.

18. A filtration device comprising:
a housing having an inlet and an outlet;
a filtration assembly disposed in the housing between the inlet and the outlet, the filtration assembly comprising:
a spacer; and
a membrane upstream or downstream of the spacer;
wherein the spacer comprises a plurality of fibers that comprise a cyclic polyolefin;
wherein the plurality of fibers is woven to obtain a plurality of through-holes for filtering particles having an average particle size of greater than 50 μm.

19. The filtration device of claim 18, wherein the plurality of fibers has a fiber diameter of 10 μm to 500 μm.

20. The filtration device of claim 18, wherein a thickness of the spacer is 20 μm to 1000 μm.
